(19) United States
(12) Patent Application Publication
(10) Pub. No.: US 2022/0298040 A1
(43) Pub. Date: Sep. 22, 2022

(54) WATER TREATMENT SYSTEM

(71) Applicants: KABUSHIKI KAISHA TOSHIBA, Tokyo (JP); TOSHIBA INFRASTRUCTURE SYSTEMS & SOLUTIONS CORPORATION, Kanagawa (JP)

(72) Inventors: Yasuhiro OHKAWA, Kawasaki Kanagawa (JP); Shuhei NODA, Yokohama Kanagawa (JP); Naoto SETO, Kawasaki Kanagawa (JP); Takumi OBARA, Fuchu Tokyo (JP); Jinyang HU, Inagi Tokyo (JP); Kenji KAKINUMA, Ota Tokyo (JP); Takeshi MATSUSHIRO, Yokohama Kanagawa (JP); Shinobu MONIWA, Kawasaki Kanagawa (JP); Nobuhiro OOTSUKI, Suginami Tokyo (JP)

(21) Appl. No.: 17/680,153

(22) Filed: Feb. 24, 2022

(30) Foreign Application Priority Data
Mar. 16, 2021 (JP) 2021-042846

(51) Int. Cl. C02F 3/00; C02F 3/08

(52) U.S. Cl. CPC C02F 3/006; C02F 3/082; C02F 2101/16

(57) ABSTRACT

A water treatment system includes a flat plate rotating so as to be partially immersed in a raw water and an imaging device configured to image the flat plate to which microorganisms adhere. The water treatment system further includes a calculator configured to calculate an amount of the microorganisms adhering to the flat plate, a controller configured to control the water treatment system and a lighting device radiating light on the flat plate.

### CROSS-REFERENCE TO RELATED APPLICATIONS

This application is based upon and claims the benefit of priority from Japanese Patent Application No. 2021-042846, filed on Mar. 16, 2021, and the entire contents of which are incorporated herein by reference.

### FIELD

Embodiments described herein relate generally to a water treatment system.

### BACKGROUND

In a water treatment system that purifies raw water by microorganisms while rotating a flat plate to which the microorganisms are adhered so that a part of the flat plate is immersed in the raw water, technologies have been developed in which the amount of microorganisms adhered to the flat plate is calculated using a contactless sensor such as a camera, and an operation of the water treatment system is automatically controlled based on the calculation result.

### BRIEF DESCRIPTION OF THE DRAWINGS

FIG. 1 is a conceptual diagram illustrating a configuration example of a water treatment system to which a water treatment method of a first embodiment is applied.

FIG. 2 is a conceptual diagram illustrating a partial configuration example of the water treatment system of the first embodiment;

FIG. 3 is a block diagram illustrating a configuration example of a controller and a monitoring device in the water treatment system of the first embodiment;

FIG. 4 is a diagram for describing an example of control processing of an imaging device and a lighting device by the controller in the water treatment system according to the first embodiment;

FIG. 5A through FIG. 5C are diagrams for describing examples of detection results of a disk body area and an edge of the disk body area captured in the monitoring device of the water treatment system according to the first embodiment;

FIG. 6 is a flowchart illustrating an example of a flow of processing of calculating an attachment amount in the water treatment system according to the first embodiment;

FIG. 7 is a flowchart illustrating another example of a flow of processing of calculating the attachment amount in the water treatment system according to the first embodiment;

FIG. 8 is a block diagram illustrating a configuration example of a controller and a monitoring device in a water treatment system according to a second embodiment;

FIG. 9 is a flowchart illustrating an example of a flow of processing of calculating an average information amount in the water treatment system according to the second embodiment;

FIG. 10 is a block diagram illustrating a configuration example of a controller and a monitoring device in a water treatment system according to a third embodiment;

FIG. 11 is a diagram for describing an example of an image obtained in the water treatment system according to the third embodiment;

FIG. 12 is a diagram for describing an example of a gaze area classified as class 0 in the water treatment system according to the third embodiment;

FIG. 13 is a diagram for describing an example of a gaze area classified as class 1 in the water treatment system according to the third embodiment;

FIG. 14 is a diagram for describing an example of a gaze area classified as class 2 in the water treatment system according to the third embodiment;

FIG. 15 is a diagram for describing an example of a gaze area classified as class 3 in the water treatment system according to the third embodiment;

FIG. 16 is a diagram for describing an example of a gaze area classified as class 4 in the water treatment system according to the third embodiment; and

FIG. 17 is a diagram illustrating an example of a result classified by the water treatment system according to the third embodiment.

### DETAILED DESCRIPTION

Hereinafter, an example of a water treatment system according to the present embodiment will be described with reference to the accompanying drawings.

### First Embodiment

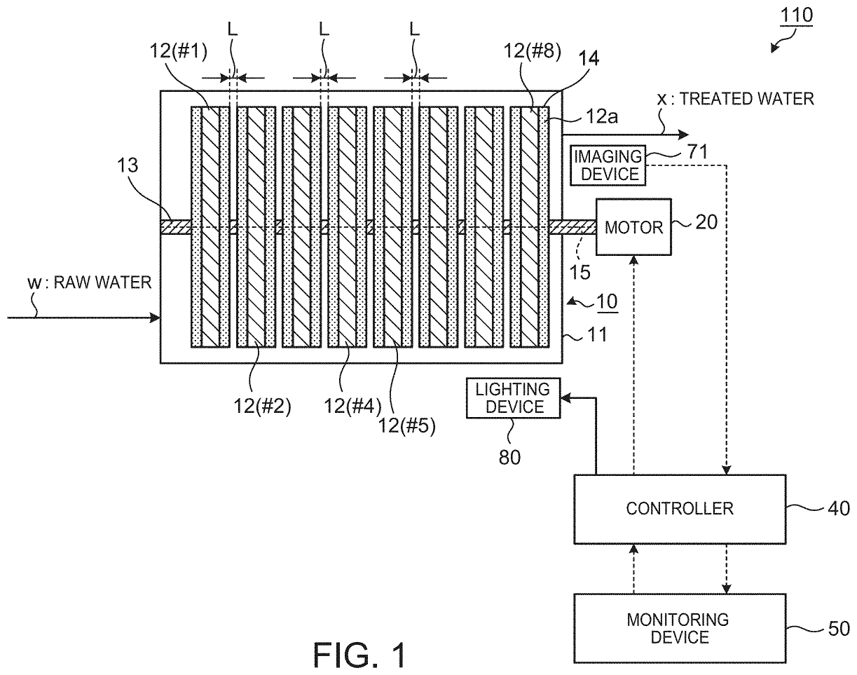

FIG. 1 is a conceptual diagram illustrating a configuration example of a water treatment system to which a water treatment method of a first embodiment is applied.

A water treatment system 110 is a system that purifies raw water w, such as organic wastewater such as sewage, agricultural wastewater, and factory wastewater, by microorganism treatment utilizing microorganisms such as Bacillus bacteria.

The water treatment system 110 includes a rotating disk device 10, a motor 20, a controller 40, a monitoring device 50, an imaging device 71 (imaging unit), and a lighting device 80 (lighting unit) as illustrated in FIG. 1.

FIG. 1 illustrates a configuration example of the rotating disk device 10 as viewed from above,

The rotating disk device 10 includes a plurality of rotating disk bodies 12 arranged in parallel at a constant interval L in a water treatment tank 11 into which the raw water w is introduced. The word rotating disk may be referred to as rotating circular plate, flat plate, and so forth.

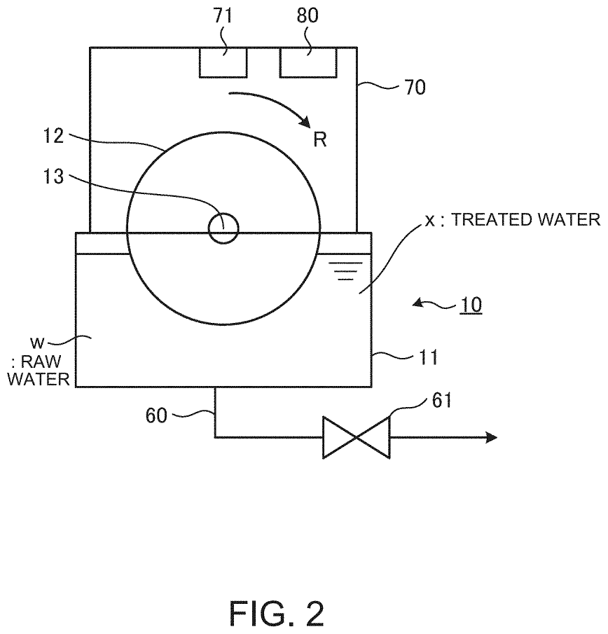

FIG. 2 is a conceptual diagram illustrating a partial configuration example of the water treatment system of the first embodiment including a configuration example in which the rotating disk device is viewed from a front surface side (raw water introduction side in FIG. 1).

A sludge drawing pipe 60 is connected to a bottom surface of the water treatment tank 11, and the sludge drawing pipe 60 is provided with a sludge drawing valve 61.

In addition, an upper portion of the water treatment tank 11 is covered with a housing cover 70, and the imaging device 71 and the lighting device 80 are provided in a space formed inside the housing cover 70.

Here, the imaging device 71 is a charge coupled device (CCD) or the like, and is an example of an imaging device that captures an image of the rotating disk body 12. In addition, the imaging device 71 is preferably an imaging device that has a wide-angle lens or a fisheye lens and can continuously image the rotating disk body 12.

The lighting device 80 is an example of a lighting device that irradiates the rotating disk body 12 with light. The lighting device 80 only needs to be able to irradiate the rotating disk body 12 with light, and is, for example, a light emitting diode (LED), a fluorescent lamp, or an organic electro luminescence (EL). Further, the lighting device 80 is not limited to a lighting device that irradiates visible light, and may be a lighting device that irradiates light of a specific wavelength such as ultraviolet light, infrared light, or white light. In the present embodiment, the water treatment system 110 includes one lighting device 80, but may include a plurality of lighting devices 80, or may include imaging device 71 and lighting device 80 as one unit.

Each rotating disk body 12 is provided with a through hole in a center of a circle, and is fixed to a shaft 13 inserted into the through hole. As a result, the respective rotating disk bodies 12 are arranged parallel to each other at a constant interval L along a long axis direction of the shaft 13.

A contact body 14 (for example, sponge body) for making microorganisms such as Bacillus bacteria dominantly easy to adhere is arranged on each rotating disk body 12. That is, in the present embodiment, the rotating disk body 12 functions as an example of a flat plate to which microorganisms are attached.

Although the raw water w is introduced into the water treatment tank 11, each rotating disk body 12 is not entirely immersed in the raw water w, but only a portion of a lower side of the each rotating disk body 12 is immersed in the raw water w, and a portion above the portion immersed by the raw water w is installed in the water treatment tank 11 so as to be in a gas phase. As a result, the upper side of each rotating disk body 12 is in contact with air, and the lower side thereof is immersed in the raw water w. Such a configuration is achieved, for example, by arranging the shaft 13 horizontally at approximately the same height as an upper edge height of the water treatment tank 11. As a result, even if the water treatment tank 11 is filled with the raw water w, the rotating disk body 12 is immersed in the raw water w only in the lower half, so that at least the upper half is in contact with the air.

The shaft 13 rotates by the driving force from the motor 20, so each rotating disk body 12 also rotates about the shaft 13 as indicated by an arrow R in FIG. 2. That is, each rotating disk body 12 passes through the center of each rotating disk body 12 and rotates about a center line 15 orthogonal to an end surface 12a of each rotating disk body 12. The rotation speed is, for example, 10 rpm during normal operation of the water treatment system 100.

As described above, each rotating disk body 12 rotates as indicated by arrow R illustrated in FIG. 2 along with the rotation of the shaft 13, so the microorganisms adhered to the contact body 14 take in oxygen in the air in the gas phase, and oxidize and decompose organic substances and nitrogen components in the raw water w while immersed in the raw water w. As a result, the treated water x from which the organic substances or the nitrogen components have been removed from the raw water w is discharged from the water treatment tank 11.

However, as such a purification operation is continued, the microorganisms adhered to the contact body 14, that is, the surface of the rotating disk body 12 proliferates. When the microorganisms adhered to the rotating disk body 12 excessively proliferate, sufficient oxygen is not distributed to the microorganisms adhered to the rotating disk body 12, and the purification performance is deteriorated. Furthermore, there may be an adverse effect such as an increase in odor or a decrease in transparency of the raw water x due to changes to anaerobic of sludge contained in the wastewater w.

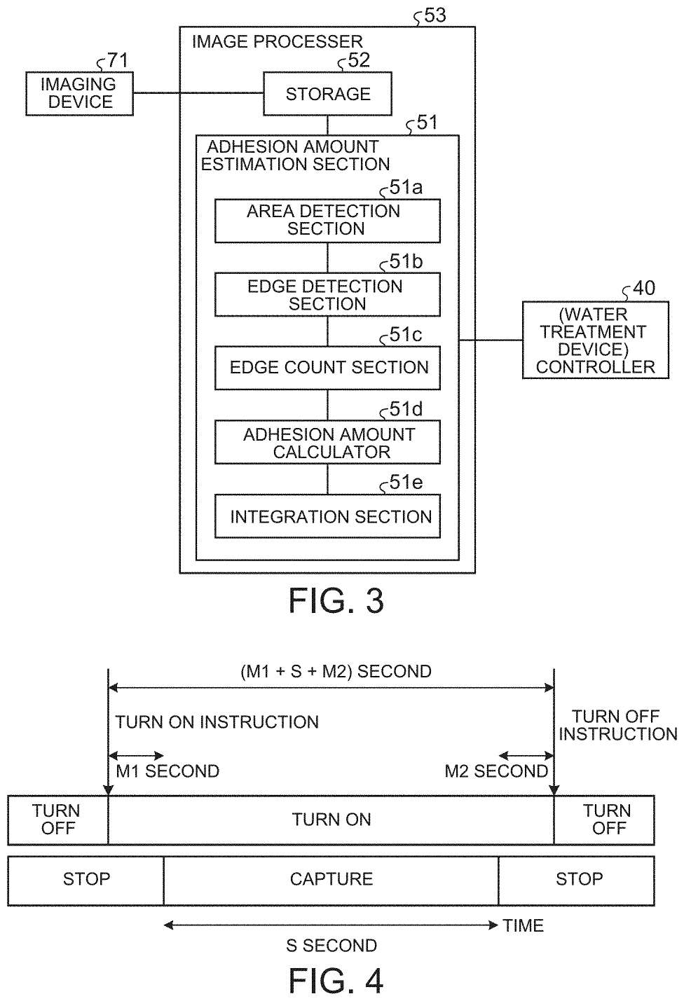

Therefore, it is necessary to perform management so that microorganisms are not excessively adhered to the rotating disk body 12. Therefore, the controller 40 estimates the adhesion amount of microorganisms adhered to rotating disk body 12, and controls the operation of water treatment system 110 such that the adhesion amount of microorganisms adhered to the rotating disk body 12 is maintained within an appropriate range when the estimation result that the microorganisms are excessively adhered is obtained. Details of the configuration of the controller 40 will be described with reference to FIG. 3. The phrase adhesion amount of microorganisms may be referred to as adhesion amount of biofilms.

FIG. 3 is a block diagram illustrating a configuration example of a controller and a monitoring device in the water treatment system of the first embodiment.

The controller 40 is an example of a controller that controls the operation of the water treatment system 110 based on the adhesion amount of microorganisms to the rotating disk body 12 calculated by the monitoring device 50.

However, when the upper portion of the water treatment tank 11 is covered with the housing cover 70, illuminance inside the water treatment tank 11 is low. In a case where the rotating disk body 12 is captured by the imaging device 71 under such low illuminance conditions, a large amount of noise is generated in the image captured by the imaging device 71 due to lack of illuminance, or the image of the rotating disk body 12 cannot be captured by the imaging device 71. Therefore, in the case where the amount of microorganisms adhered to the rotating disk body 12 is calculated (estimated) based on the image captured by the imaging device 71, the calculation accuracy of the amount of microorganisms adhered may be significantly reduced.

Therefore, in the present embodiment, the water treatment system 110 includes the lighting device 80 that irradiates the rotating disk body 12 with light as described above. As a result, it is possible to increase the illuminance inside the water treatment tank 11 to prevent generation of a large amount of noise in the image captured by the imaging device 71 or failure in the imaging of the image of the rotating disk body 12 by the imaging device 71. As a result, in the case where the amount of microorganisms adhered to the rotating disk body 12 is calculated (estimated) based on the image captured by the imaging device 71, the calculation accuracy of the amount of microorganisms adhered may be significantly reduced.

However, when the lighting device 80 is provided in the water treatment tank 11 and turned on, the following problems is likely to occur in the water treatment tank 11.

1. Algae outbreak (since the inside of the water treatment tank 11 has a large amount of water and nutrients, in the environment where light is constantly exposed, algae may be photosynthesized and generated in a large amount, which may lead to the hinder the dominance of useful microorganisms.)

2. Insect invasion

3. Wasted power consumption

4. Decrease in life of lighting device

Therefore, it is preferable to minimize the lighting of the lighting device 80 in the water treatment tank 11. Thus, the controller 40 controls the imaging device 71 to start and stop capturing and the lighting device 80 to be turned on and turned off. As a result, since it is possible to minimize the lighting of the lighting device 80 in the water treatment tank 11, the possibility of the above-described problems occurring in the water treatment tank 11 can be reduced. Specifically, since the amount of microorganisms adhered to the rotating disk body 12 does not increase sharply, it is only required to capture an image of the rotating disk body 12 with the imaging device 71 about once an hour. Further, when the rotating disk body 12 rotates at 10 rpm, the imaging device 71 can image the entire circumference of the rotating disk body 12 in 6 seconds, so the controller 40 only has to turn on the lighting device 80 for about 6 seconds per hour. Similarly for the imaging device 71, the controller 40 does not need to constantly capture the image of the rotating disk body 12, so the storage capacity required for storing the image captured by the imaging device 71 can be saved.

In the present embodiment, the controller 40 instructs the imaging device 71 to start imaging and the lighting device 80 to be turned on at a predetermined time. Here, the predetermined time is a preset time, for example, 0 minutes per hour or at night. For example, the controller 40 captures an image by the imaging device 71 and turns on the lighting device 80 at a predetermined time for a predetermined period T. Here, the predetermined period T is a preset period, for example, a preset number of seconds.

In addition, in the present embodiment, it is also possible that the controller 40 instructs the imaging device 71 to start the imaging and the lighting device 80 to be turned on at a predetermined interval. Here, the predetermined interval is a preset time, for example, 30 minutes. For example, the controller 40 captures the image by the imaging device 71 and turns on the lighting device 80, at a predetermined interval for a predetermined period T.

Further, in the present embodiment, it is also possible that the controller 40 instructs the imaging device 71 to capture an image and the lighting device 80 to be turned on when a predetermined event occurs. Here, the predetermined event is a preset event, and is, for example, a case where cleaning treatment of the water treatment system 110 is executed, a case where maintenance of the water treatment system 110 is performed, or a case where there is an instruction from an external device. For example, in the case where the predetermined event occurs, the controller 40 controls the imaging device 71 to capture an image and the lighting device 80 to be turned on for a predetermined time T.

In the present embodiment, the controller 40 controls the imaging device 71 to capture an image and the lighting device 80 to be turned on at the same timing, but a period from the start of capturing to the stop of capturing by the imaging device 71 and a period from the turn on to the turn off of the lighting device 80 may be different. For example, the controller 40 may set the time when the imaging device 71 captures an image to 5 seconds, and set the time when the lighting device 80 is turned on to 10 seconds. That is, in the controller 40, the period from the start of capturing to the stop of capturing by the imaging device 71 and the period from the turn on to the turn off of the lighting device 80 do not need to completely coincide with each other, and only have to overlap at least partially.

FIG. 4 is a diagram for describing an example of control processing of the imaging device and the lighting device by the controller in the water treatment system according to the first embodiment. For example, as illustrated in FIG. 4, the controller 40 instructs the imaging device 71 to start capturing after M1 seconds have elapsed from instructing the lighting device 80 to be turned on. Then, when S seconds have elapsed after instructing the imaging device 71 to start capturing, the controller 40 instructs the imaging device 71 to stop capturing as illustrated in FIG. 4. Then, after M2 seconds have elapsed from instructing the imaging device 71 to stop capturing, the controller 40 instructs the lighting device 80 to turn off the light as illustrated in FIG. 4.

Returning to FIG. 3, in the present embodiment, it is also possible that the controller 40 causes the imaging device 71 to constantly capture an image and instruct the lighting device 80 to be turned on at a predetermined time or at a predetermined interval. In this case, an adhesion amount calculation section 51d (adhesion amount calculator) to be described later calculates the adhesion amount of microorganisms to the rotating disk body 12 based on the image captured by the imaging section 71 while the lighting device 80 is turned on.

The monitoring device 50 includes an image processor 53 (image processing unit). The image processor 53 includes an adhesion amount estimation section 51 for estimating the adhesion amount of microorganisms to the rotating disk body 12, and a storage 52 (storage section) for storing the image captured by the imaging device 71.

As described above, the storage 52 stores the image captured by the imaging device 71. The image stored in the storage 52 is used for estimating the adhesion amount of microorganisms by the adhesion amount estimation section 51. The images stored in the storage 52 may be sequentially transmitted to the adhesion amount estimation section 51, or after the preset number N (N is an integer of 1 or more) is stored in the storage 52, N images stored in the storage 52 may be collectively transmitted to the adhesion amount estimation section 51.

As illustrated in FIG. 3, the adhesion amount estimation section 51 includes an area detection section 51a, an edge detection section 51b, an edge count section 51c, an adhesion amount calculation section 51d (adhesion amount calculator), and an integration section 51e.

The area detection section 51a is an example of an area detection section that detects a disk body area (an example of a flat plate image area), which is the area of the rotating disk body 12, from the image stored in the storage 52. The image captured by the imaging section 71 also includes an image of a subject other than the rotating disk body 12. Therefore, the area detection section 51a detects the disk body area from the image stored in storage 52.

For example, a relative position between the rotating disk body 12 and the imaging device 71 is fixed so that the disk body area always appears at the same position in the image. Then, the area detection section 51a may detect a preset mask area of the image as the disk body area. Further, for example, the area detection section 51a may detect the disk body area from the image using an image recognition technology such as template matching. In the present embodiment, the disk body area is detected from the image by the area detection section 51a, but when the entire image is the disk body area, the detection processing of the disk body area by the area detection section 51a may not be executed.

The edge detection section 51b is an example of an edge detection section that detects an edge of the disk body area detected by the area detection section 51a. In other words, the edge detection section 51b specifies an image of an edge included in the disk body area. For example, the edge detection section 51b detects a pixel in which the edge exists from the disk body area by using a canny or the like. Alternatively, the edge detection section 51b may calculate a gradient of the disk body area using a sobel filter, a roberts filter, or the like, perform binarization processing on the disk body area on the basis of the calculation result of the gradient, and then detect a pixel having an edge in the disk body area.

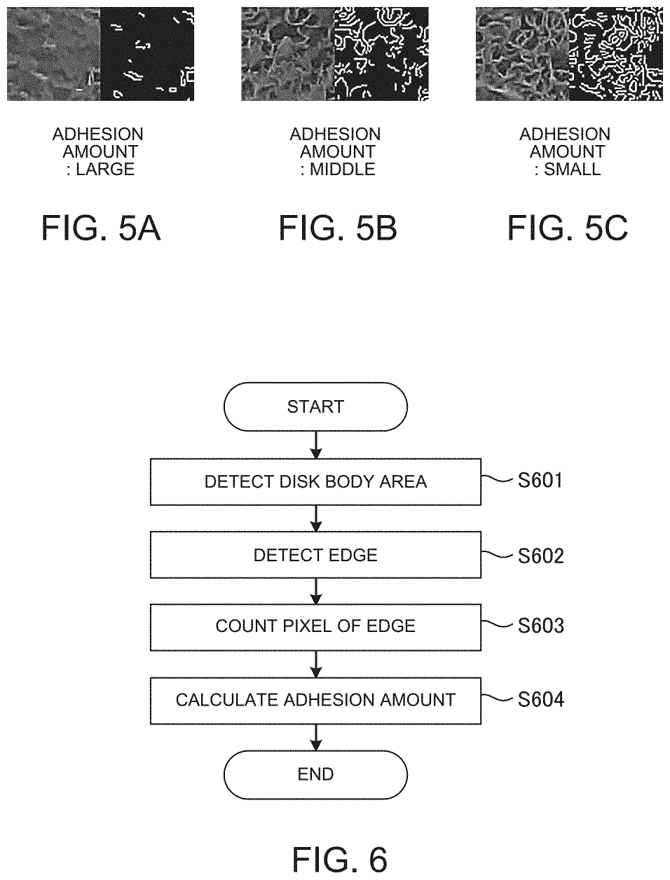

FIG. 5 is a diagram for describing an example of detection results of a disk body area and an edge of the disk body area captured in the monitoring device of the water treatment system according to the first embodiment. FIGS. 5A, 5B, and 5C illustrate the detection results of the disk body area having different adhesion amounts of microorganisms and the edge of the disk body area (indicated by white pixels in the image on the right). As illustrated in FIG. 5, as the adhesion amount of microorganisms to the rotating disk body 12 increases, the number of edges decreases, and as the adhesion amount of microorganisms to the rotating disk body 12 decreases, the number of edges increases. As the adhesion amount increases, the unevenness on the surface of the disk body decreases, and the number of edges decreases.

Returning to FIG. 3, the edge count section 51c counts the edge detected by the edge detection section 51b.

The adhesion amount calculation section 51d is an example of an adhesion amount calculation section that calculates (estimates) the adhesion amount of microorganisms to the rotating disk body 12 based on the disk body area and the detection result of the edge by the edge detection section 51b. In the present embodiment, the adhesion amount calculation section 51d calculates the attachment amount of microorganisms to the rotating disk body 12 based on the disk body area and the count result of the edge by an edge count section 51c. For example, the adhesion amount calculation section 51d calculates the adhesion amount of microorganisms to the rotating disk body 12 using the following Formula (1).

Adhesion amount=1−(Number of pixels of edge/Number of pixels of disk body area) (1)

In a state where the amount of microorganisms adhered to the rotating disk body 12 is small, the contact body 14 (spongy body or the like) constituting the rotating disk body 12 is exposed, so the edge component of the disk body area increases. On the other hand, when the adhesion amount of microorganisms to the rotating disk body 12 increases, the contact body 14 constituting the rotating disk body 12 is covered with the microorganisms, and the edge component of the disk body area decreases. Therefore, in the present embodiment, the adhesion amount calculation section 51d quantifies the adhesion amount of microorganisms to the rotating disk body 12 based on the ratio of the edge in the disk body area. As a result, it is possible to improve the calculation accuracy of the adhesion amount of microorganisms to the rotating disk body 12 using the image obtained by imaging the rotating disk body 12.

In the present embodiment, the adhesion amount calculation section 51d calculates the adhesion amount of microorganisms to the rotating disk body 12 based on the disk body area and the detection result of the edge, but the adhesion amount of microorganisms to the rotating disk body 12 may be calculated based on an image of a curve in the disk body area. For example, the adhesion amount calculation section 51d determines that the adhesion amount of microorganisms to the rotating disk body 12 increases as the number of curved images in the disk body area decreases.

The integration section 51e integrates the adhesion amounts respectively calculated based on the plurality of images (disk body areas). For example, the integration section 51e calculates an average value, a median value, a mode value, a maximum value, a minimum value, a quartile value, and the like of the adhesion amounts respectively calculated on the basis of the plurality of images (for example, images, the preset number of which is M).

FIG. 6 is a flowchart illustrating an example of a flow of processing of calculating the adhesion amount in the water treatment system according to the first embodiment. Next, an example of a flow of processing of calculating the adhesion amount in the water treatment system 110 according to the present embodiment will be described with reference to FIG. 6.

First, the area detection section 51a detects the disk body area from the image stored in storage 52 (step S601). Next, the edge detection section 51b detects the edge from the disk body area detected by the area detection section 51a (step S602). Next, the edge count section 51c counts the edge detected from the disk body area by the edge detection section 51b (step S603). Then, the adhesion amount calculation section 51d calculates the adhesion amount of microorganisms to the rotating disk body 12 based on the disk body area and the count result of the edge by the edge count section 51c (step S604).

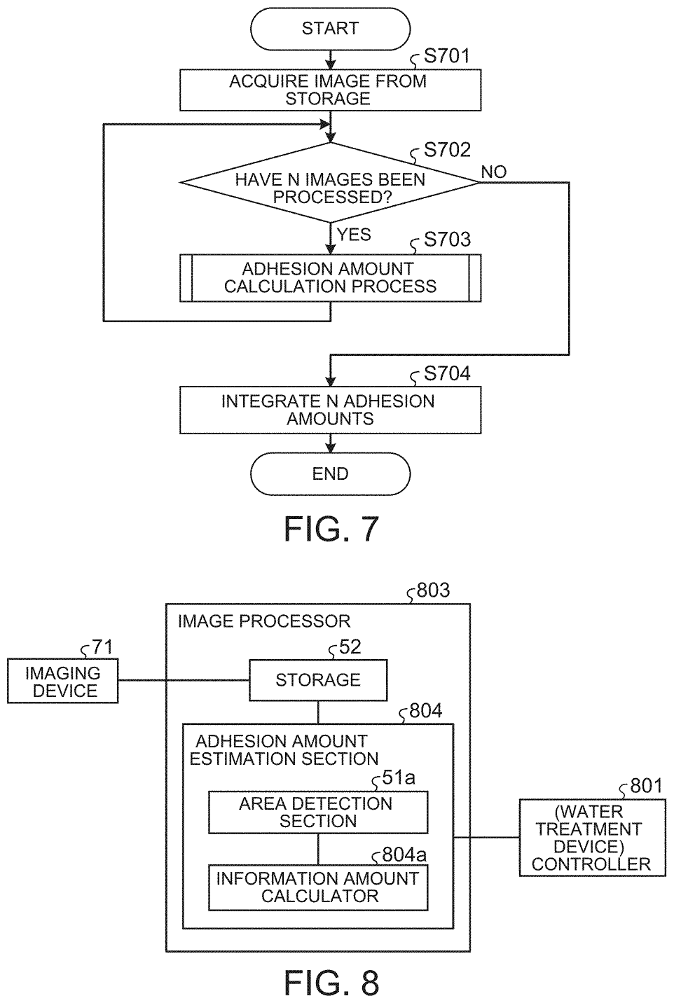

FIG. 7 is a flowchart illustrating another example of the flow of the adhesion amount calculation processing in the water treatment system according to the first embodiment. Next, another example of the flow of the processing of calculating the adhesion amount in the water treatment system 110 according to the present embodiment will be described with reference to FIG. 7.

First, the attachment amount estimation section 51 acquires an image from the storage 52 (step S701). Next, the adhesion amount estimation section 51 determines whether the processing of calculating the adhesion amount has been executed based on the images, the preset number of which is M (step S702).

When the adhesion amount has not been calculated based on the images, the preset number of which is M (step S702: No), the adhesion amount estimation section 51 calculates the adhesion amount in the same manner as the processing of calculating the adhesion amount (steps S601 to S604) illustrated in FIG. 6 (step S703). On the other hand, when the adhesion amount is calculated based on the images, the preset number of which is M (step S702: Yes), the integration section 51e executes the processing of integrating the adhesion amounts respectively calculated based on the images, the preset number of which is M (step S704).

The embodiment provides a water treatment system that purifies raw water by microorganisms while rotating a flat plate to which the microorganisms are adhered so that a part of the flat plate is immersed in the raw water. The water treatment system includes an imaging device that captures an image of the flat plate, a calculation section that calculates an adhesion amount of microorganisms to the flat plate based on the image captured by the imaging device, a controller that controls an operation of the water treatment system based on the adhesion amount calculated by the calculation section, and a lighting device that irradiates the flat plate with light.

The embodiment provides the water treatment system enable to improve calculation accuracy of the amount of microorganisms adhered to the flat plate.

As described above, according to the water treatment system 110 of the first embodiment, it is possible to increase the illuminance inside the water treatment tank 11 to prevent generation of a large amount of noise in the image captured by the imaging device 71 or failure in capturing the image of the rotating disk body 12 by the imaging device 71. As a result, in the case where the amount of microorganisms adhered to the rotating disk body 12 is calculated based on the image captured by the imaging device 71, the calculation accuracy of the amount of microorganisms adhered may be significantly reduced. In addition, according to the water treatment system 110 according to the first embodiment, by quantifying the adhesion amount of microorganisms to the rotating disk body 12 based on the ratio of the edge in the disk body area, it is possible to improve the calculation accuracy of the adhesion amount of microorganisms to the rotating disk body 12 using the image obtained by imaging the rotating disk body 12.

### Second Embodiment

The present embodiment is an example of controlling an operation of a water treatment system based on an average information amount of a disk body area. In the following description, description of the same configuration as that of the first embodiment will be omitted.

FIG. 8 is a block diagram illustrating a configuration example of a controller and a monitoring device in the water treatment system according to the second embodiment. As illustrated in FIG. 8, a water treatment system 110 according to the present embodiment includes a controller 801 and a monitoring device 50 (see FIG. 1).

A controller 801 controls an operation of the water treatment system 110 based on the average information amount of the disk body area calculated by the monitoring device 50.

The monitoring device 50 includes an image processor 803 (image processing unit). The image processor 803 includes an adhesion amount estimation section 804 and a storage 52. The adhesion amount estimation section 804 includes an area detection section 51a and an information amount calculation section 804a (information amount calculator).

The information amount calculation section 804a is an example of an information amount calculation section that calculates the average information amount of the disk body area detected by the area detection section 51a. For example, when the disk body area is an 8-bit (256-gradation) image, the information amount calculation section 804a calculates the average information amount E of the disk body area by using the following Formula (2).

E=−Σp_i*log 2(p_i) (2)

Here, i is 0 to 255 gradations. Further, p_i is (number of pixels whose luminance value is i in the disk body area)/(number of pixels in the disk body area), that is, p_i is a ratio of pixels whose luminance value is i in the disk body area. The sign “*” is a multiplication sign.

In the present embodiment, an information amount calculation section 804a calculates the average information amount E using the disk body area detected by the area detection section 51a as it is, but may obtain a gradient of the disk body area by filter processing such as a sobel filter and a Gaussian filter, execute binarization processing or the like on the disk body area based on the gradient, and then calculate the average information amount E of the disk body area. That is, the information amount calculation section 804a may execute preset image processing (for example, filter processing and binarization processing) on the disk body area and then calculate average information amount E of the flat plate image area.

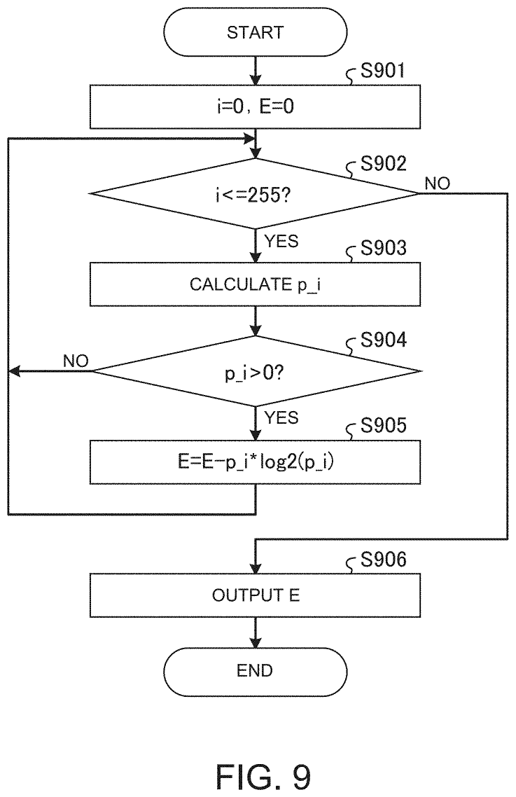

FIG. 9 is a flowchart illustrating an example of a flow of processing of calculating the average information amount in the water treatment system according to the second embodiment. Next, an example of a flow of processing of calculating the average information amount E in the water treatment system 110 according to the present embodiment will be described with reference to FIG. 9.

The information amount calculation section 804a first sets i to 0 and sets E to 0 (step S901). Next, the information amount calculation section 804a determines whether i is 255 or less (step S902).

Next, the information amount calculation section 804a calculates p_i (step S903). Then, when p_i is greater than 0 (step S904: Yes), the information amount calculation section 804a calculates an average information amount E=E−p_i*log 2 (p_i) (step S905), and returns to step S902. Meanwhile, when p_i is 0 or less (step S904: No), the information amount calculation section 804a returns to step S902.

Thereafter, when i is greater than 255 (step S902: No), the information amount calculation section 804a outputs the calculation result of the average information amount E to the controller 801 (step S906).

As described above, according to the water treatment system 800 of the second embodiment, by controlling the operation of the water treatment system 110 based on the average information amount of the disk body area, it is possible to automatically control the operation of the water treatment system 110 according to the adhesion amount of microorganisms to the rotating disk body 12.

### Third Embodiment

The present embodiment is an example in which a model representing the relationship between a feature amount of a disk body area and the adhesion amount of microorganisms to a rotating disk body is learned, and the adhesion amount corresponding to the feature amount of the disk body area is estimated using the learned model. In the following description, description of the same configuration as that of the above-described embodiments will be omitted.

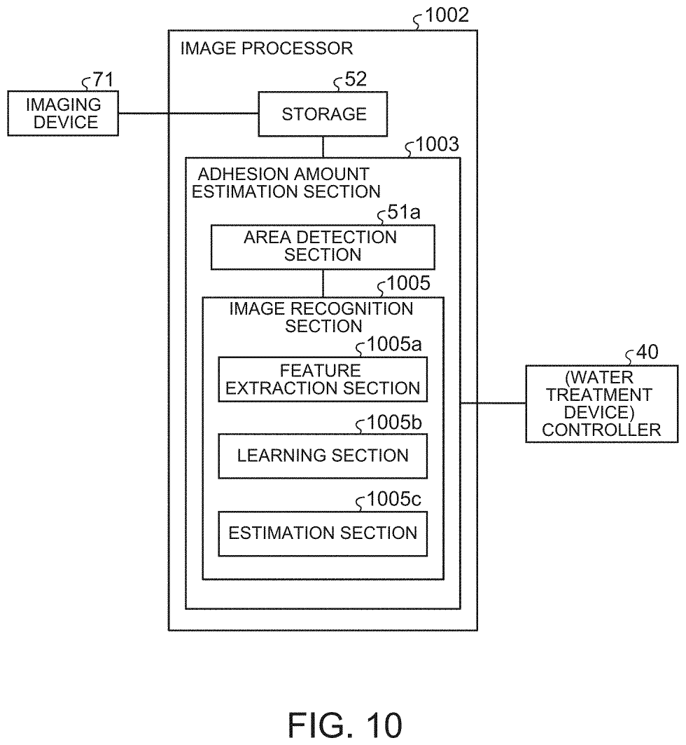

FIG. 10 is a block diagram illustrating a configuration example of a controller and a monitoring device in the water treatment system according to the third embodiment. The monitoring device 50 of the water treatment system 110 according to the present embodiment includes an image processor 1002 (image processing unit). The image processor 1002 includes an adhesion amount estimation section 1003 and a storage 52. The adhesion amount estimation section 1004 includes an area detection section 51a and an image recognition section 1005. The image recognition section 1005 includes a feature extraction section 1005a, a learning section 1005b, and an estimation section 1005c.

The feature extraction section 1005a extracts a feature amount (hereinafter, it is referred to as an image feature amount) from the disk body area detected by the area detection section 51a. For example, the feature extraction section 1005a may extract a high-order local autocorrelation feature, a histogram of gradient (Hog), an image of a disk body area as it is, or the like as the image feature amount.

The learning section 1005b is an example of a learning section that learns a model representing the relationship between the image feature amount and the adhesion amount of microorganisms to the rotating disk body 12. For example, the learning section 1005b learns a model representing the relationship between the image feature amount and the adhesion amount by multiple regression analysis, deep neural net (DNN), convolutional neural net (CNN), or the like.

The estimation section 1005c functions as an example of the estimation section that estimates the adhesion amount corresponding to the image feature amount using the model learned by the learning section 1005b.

An example of the flow of the process of estimating the adhesion amount in the water treatment system 110 according to the present embodiment will be described. In the present embodiment, a deep neural net (DNN) is adopted as an example.

FIG. 11 is a diagram for describing an example of an image obtained in the water treatment system according to the third embodiment. First, one or more gaze areas 1010 (watch areas, observation areas) are set in the image obtained from the imaging device 71. In the present embodiment, the gaze area 1010 is rectangular, but may have another shape such as a circular shape. In addition, the entire image may be used as gaze area 1010. The number of gaze areas 1010 is not limited to one, and may be plural. When a plurality of gaze areas 1010 are provided, the gaze areas 1010 may have an overlapping area. In the present embodiment, the gaze area 1010 is a square having a height of 80 pixels and a width of 80 pixels.

Next, the gaze area 1010 is cut out from the image obtained from the imaging device 71, and the cut out gaze area 1010 is classified into five classes from class 0 to class 4.

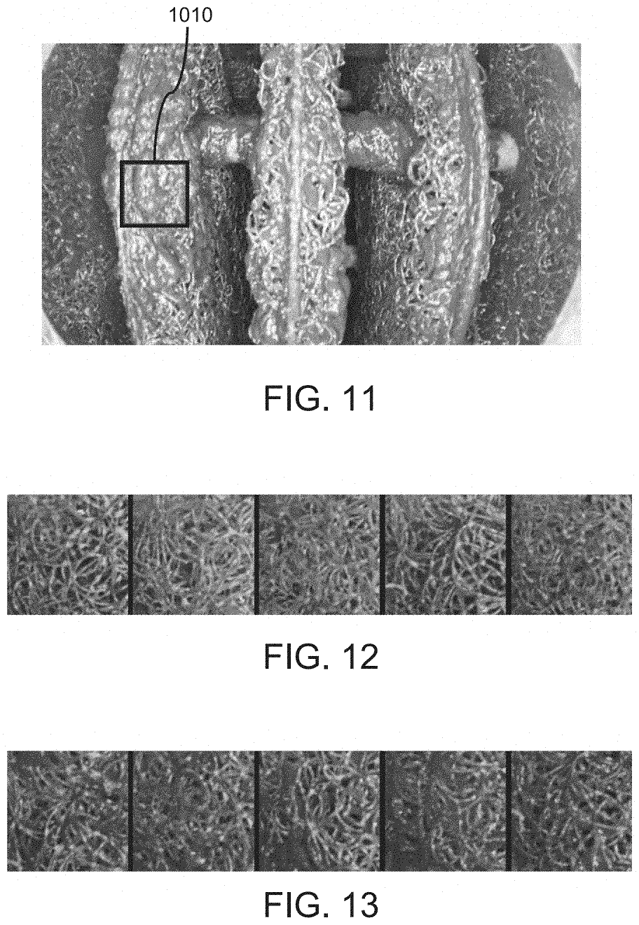

FIG. 12 is a diagram for describing an example of a gaze area classified as class 0 in the water treatment system according to the third embodiment.

FIG. 13 is a diagram for describing an example of a gaze area classified as class 1 in the water treatment system according to the third embodiment.

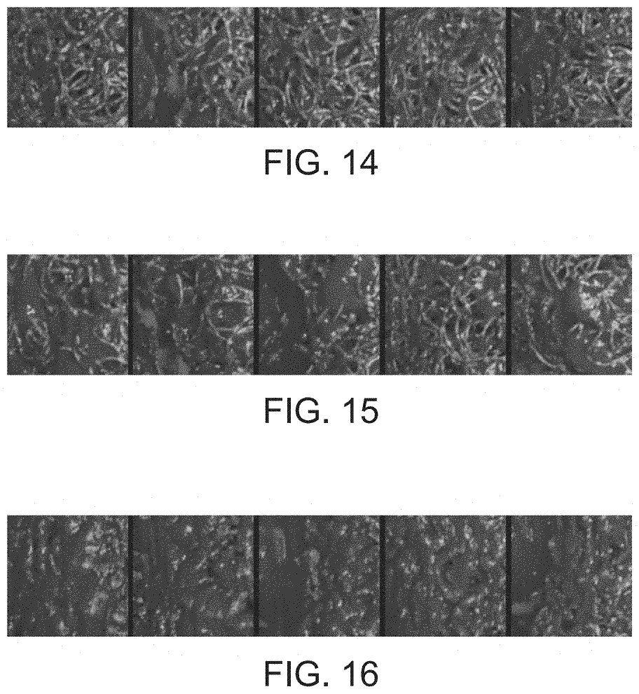

FIG. 14 is a diagram for describing an example of a gaze area classified as class 2 in the water treatment system according to the third embodiment.

FIG. 15 is a diagram for describing an example of a gaze area classified as class 3 in the water treatment system according to the third embodiment.

FIG. 16 is a diagram for describing an example of a gaze area classified as class 4 in the water treatment system according to the third embodiment.

The gaze area 1010 cut out from the image obtained from the imaging device 71 is classified into classes 0 to 4 based on the adhesion amount of microorganisms or biofilms. When microorganisms or biofilms are thinly adhered to the rotating disk body 12, but a mass of microorganisms or biofilms are hardly adhered, the gaze area 1010 is classified into class 0. When the mass of microorganisms or biofilms is adhered to the rotating disk body 12 by about 10 to 20%, about 30 to 50%, about 60 to 80%, or 90% or more, the gaze area 1010 is classified into class 1, class 2, class 3, or class 4, respectively.

The above classification method is an example, and the gaze area 1010 cut out from the image may be classified into two or more classes. For example, the gaze area 1010 may be classified into three classes so that when the mass of microorganisms or biofilms is 30% or less, the gaze area 1010 is classified into class 0, when the mass of microorganisms or biofilms exceeds 30% and is 70% or less, the gaze area 1010 is classified into class 1, and when the mass of microorganisms or biofilms exceeds 70%, the gaze area 1010 is classified into class 2. Further, although the classification is performed visually in the present embodiment, the amount of microorganisms or biofilms may be measured by other measuring methods and may be classified based on the measured results.

In the present embodiment, by 100 images for each class, a total of 500 images were collected. By 50 sheets for each class, a total of 250 sheets were used for learning of DNN, and the remaining 250 sheets were used for evaluation. The network of the DNN of the present embodiment includes 11 convolution layers, 4 pooling layers, and 2 fully connected layers. Learning was performed using Softmax Cross Entropy as a loss function. The configuration, layer, and loss function of the network are not limited to those described above, and may be those generally used for DNN.

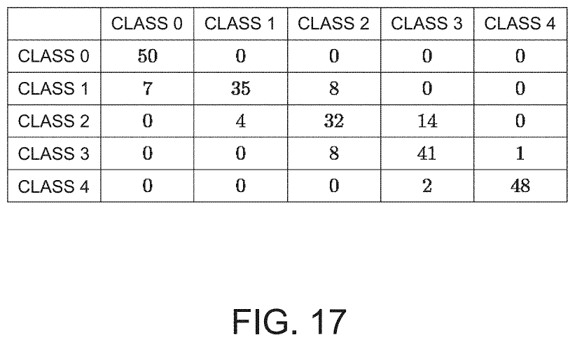

FIG. 17 is a diagram illustrating an example of a result classified by the water treatment system according to the third embodiment. A row of a matrix illustrated in FIG. 17 indicates a correct answer class, and a column indicates a class classified by the water treatment system 110 according to the present embodiment. As a result of classifying the evaluation data with the learned model, an 82.4% correct answer rate was obtained. From the above results, it was shown that the gaze area 1010 can be accurately classified into five classes by this algorithm.

A method of calculating an adhesion amount using the above classification result will be described. First, the rotating disk body 12 is imaged, one or more (for example, N) gaze areas are cut out from the image obtained by the imaging, and N results classified by the DNN are obtained. Then, N results are integrated as the adhesion amount S=0.00 for the image classified into class 0, the adhesion amount S=0.25 for the image classified into class 1, the adhesion amount S=0.50 for the image classified into class 2, the adhesion amount S=0.75 for the image classified into class 3, and the adhesion amount S=1.00 for the image classified into class 4.

Here, the correspondence between the classified result and the adhesion amount is an example, and other correspondence methods may be used.

As described above, according to the water treatment system 110 of the third embodiment, by calculating the adhesion amount of microorganisms to the rotating disk body 12 using the model representing the relationship between the image feature amount of the disk body area and the adhesion amount of microorganisms to the rotating disk body 12, it is possible to improve the calculation accuracy of the attachment amount of microorganisms to the rotating disk body 12 using the image obtained by imaging the rotating disk body 12.

As described above, according to the first to third embodiments, in a case where the attachment amount of microorganisms to the rotating disk body 12 is calculated on the basis of the image captured by the imaging device 71, it is possible to suppress the calculation accuracy of the attachment amount of microorganisms from decreasing.

In the above embodiments, image processors 53, 803 and 1002 are used. The image processor in each embodiment, or a component including the image processor and controller, is configured as a computer including, for example, CPU (Central Processing Unit), RAM (Random Access Memory), ROM (Read Only Memory), and the function of the image processor and controller is realized by executing a program. However, the image processor and controller may be partially or entirely configured by hardware such as a circuit including ASIC (Application Specific Integrated Circuit) or FPGA (Field Programmable Gate Array).

Although some embodiments of the present invention have been described, these embodiments are presented as examples and are not intended to limit the scope of the invention These novel embodiments can be implemented in various other forms, and various omissions, replacements, and changes can be made without departing from the spirit of the invention. These embodiments and modifications thereof are included in the scope and the gist of the invention, and are also included in the invention described in the claims and the scope equivalent thereto.

What is claimed is:

1. A water treatment system comprising:
a flat plate rotating so as to be partially immersed in a raw water;
an imaging device configured to image the flat plate to which microorganisms adhere;
a calculator configured to calculate an amount of the microorganisms adhering to the flat plate;
a controller configured to control the water treatment system; and
a lighting device radiating light on the flat plate.

2. The water treatment system according to claim 1, wherein the controller further controls the imaging device to start and stop imaging and the lighting device to be turned on and turned off.

3. The water treatment system according to claim 2, wherein the controller instructs the imaging device to start the imaging and the lighting device to be turned on, at a preset time.

4. The water treatment system according to claim 2, wherein the controller instructs the imaging device to start the imaging and the lighting device to be turned on, at a preset interval.

5. The water treatment system according to claim 2, wherein the controller at least partially overlaps a period from the start to the stop of the imaging by the imaging device and a period from the turn on to the turn off of the lighting device.

6. The water treatment system according to claim 3, wherein the preset time is nighttime.

7. The water treatment system according to claim 2, wherein the controller instructs the imaging device to start the imaging and the lighting device to be turned on when a predetermined event occurs.

8. The water treatment system according to claim 1, wherein the calculator includes,
an area detection section configured to detect an area of the flat plate from an image of the flat plate;
an edge detection section configured detect an edge of the area of the flat plate; and
an information amount calculator configured to calculate an amount of microorganisms adhering to the flat plate depending on the area of the flat plate and the detected edge.

9. The water treatment system according to claim 1, wherein the calculator includes,
an area detection section configured to detect an area of the flat plate from an image of the flat plate; and
an information amount calculator configured to calculate an average of information amount.

10. The water treatment system according to claim 9, wherein the information amount calculator calculates the average of information amount of the area of the flat plate after executing preset image processing on the area of the flat plate.

11. The water treatment system according to claim 1, wherein the calculator includes,
an area detection section configured to detect an area of the flat plate from an image of the flat plate;
a learning section configured to learn a model that represents a relationship between a feature amount of an area of the flat plate from an image of the flat plate and the amount of microorganisms adhering to the flat plate; and
an estimation section configured to estimate an amount of microorganisms adhering to the flat plate corresponding to the feature amount of an area of the flat plate using the model learned by the learning section.

12. A water treatment system comprising:
a flat plate rotating so as to be partially immersed in a raw water;
an imaging device configured to image the flat plate to which microorganisms adhere;
an area detection section configured to detect an area of the flat plate from an image of the flat plate;
an edge detection section configured detect an edge of the area of the flat plate;
an information amount calculator configured to calculate an amount of microorganisms adhering to the flat plate depending on the area of the flat plate and the detected edge; and
a controller configured to control the water treatment system depending on the amount of microorganisms adhering to the flat plate.

13. A water treatment system comprising:
a flat plate rotating so as to be partially immersed in a raw water;
an imaging device configured to image the flat plate to which microorganisms adhere;
an area detection section configured to detect an area of the flat plate from an image of the flat plate;
an information amount calculator configured to calculate an average of information amount; and
a controller configured to control the water treatment system depending on the average of information amount.

14. The water treatment system according to claim 13, wherein the information amount calculator calculates the average of information amount of the area of the flat plate after executing preset image processing on the area of the flat plate.

15. A water treatment system comprising:
a flat plate rotating so as to be partially immersed in a raw water;
an imaging device configured to image the flat plate to which microorganisms adhere;
an area detection section configured to detect an area of the flat plate from an image of the flat plate;
a learning section configured to learn a model that represents a relationship between a feature amount of an area of the flat plate from an image of the flat plate and the amount of microorganisms adhering to the flat plate;
an estimation section configured to estimate an amount of microorganisms adhering to the flat plate corresponding to the feature amount of an area of the flat plate using the model learned by the learning section; and
a controller configured to control the water treatment system depending on the amount of microorganisms adhering to the flat plate.
